(19) United States
(12) Patent Application Publication
(10) Pub. No.: US 2022/0036204 A1
(43) Pub. Date: Feb. 3, 2022

(54) LEARNING APPARATUS, ESTIMATION APPARATUS, PARAMETER CALCULATION METHOD AND PROGRAM

(71) Applicant: NIPPON TELEGRAPH AND TELEPHONE CORPORATION, Tokyo (JP)

(72) Inventors: Tomoharu IWATA, Tokyo (JP); Yuki YAMANAKA, Tokyo (JP)

(73) Assignee: NIPPON TELEGRAPH AND TELEPHONE CORPORATION, Tokyo (JP)

(21) Appl. No.: 17/299,679

(22) PCT Filed: Dec. 2, 2019
(86) PCT No.: PCT/JP2019/047093

§ 371 Date: Jun. 3, 2021

(30) Foreign Application Priority Data
Dec. 5, 2018 (JP) 2018-228516

(51) Int. Cl. G06N 5/02; G06N 5/04

(52) U.S. Cl. CPC G06N 5/022; G06N 5/04

(57) ABSTRACT

A learning apparatus includes an input data reading unit configured to input data and a label indicating whether the data is abnormal, an objective function calculation unit configured to calculate a value of an objective function based on the label and a predetermined function for calculating an anomaly score of the data by applying a parameter relating to the anomaly score, by using the data and a value of the parameter, and a parameter update unit configured to calculate a value of the parameter that maximizes the value of the objective function by repeatedly executing a process by the objective function calculation unit while updating the value of the parameter.

### TECHNICAL FIELD

The present disclosure relates to techniques for estimating the anomaly score included in data, when the data is provided.

### BACKGROUND ART

A task of detecting an anomaly when data is provided is called anomaly detection. The technique for anomaly detection is used in the detection of, for example, equipment anomaly, network anomaly, and credit card scam.

An unsupervised method has been proposed as an anomaly detection method (for example, Non Patent Literature 1). However, when an anomaly label is given to indicate whether each piece of data is abnormal, there is a problem in the unsupervised method in the related art that the anomaly label cannot be effectively used.

In addition, a supervised method has also been proposed as an anomaly detection method (for example, Non-Patent Literature 2). However, in a supervised method in the related art, there is a problem that high performance cannot be achieved when the amount of abnormal data is small.

### CITATION LIST

### Non Patent Literature

Non Patent Literature 1: Liu, Fei Tony, Kai Ming Ting, and Zhi-Hua Zhou. “Isolation forest.” 2008 Eighth IEEE International Conference on Data Mining. IEEE, 2008. Non Patent Literature 2: Zhang, J., Zulkemine, M., & Haque, A. (2008). Random-forests-based network intrusion detection systems. IEEE Transactions on Systems, Man, and Cybernetics. Part C (Applications and Reviews), 38(5), 649-659.

### SUMMARY OF THE INVENTION

### Technical Problem

The present disclosure has been made in view of the above points, and an object of the present disclosure is to provide a technique that makes it possible to estimate the anomaly score with high performance, by effectively utilizing an anomaly label, when data and the anomaly label are provided.

### Means for Solving the Problem

According to the disclosed technique, provided is a learning apparatus including: an input data reading unit configured to input data and a label indicating whether the data is abnormal; an objective function calculation unit configured to calculate a value of an objective function based on the label and a predetermined function for calculating an anomaly score of the data by applying a parameter relating to the anomaly score, by using the data and a value of the parameter; and a parameter update unit configured to calculate a value of the parameter that maximizes the value of the objective function by repeatedly executing a process by the objective function calculation unit while updating the value of the parameter.

### Effects of the Disclosure

According to the disclosed technique, a technique is provided that makes it possible to estimate the anomaly score with high performance, by effectively utilizing an anomaly label, when data and the anomaly label are provided.

### BRIEF DESCRIPTION OF DRAWINGS

FIG. 1 is a configuration diagram of a system according to an embodiment of the present disclosure.

FIG. 2 is a diagram illustrating an example of a hardware configuration of the apparatus.

FIG. 3 is a flowchart of processes of a learning apparatus.

FIG. 4 is a diagram illustrating evaluation results of the present disclosure.

### DESCRIPTION OF EMBODIMENTS

Hereinafter, embodiments of the present disclosure will be described in detail with reference to the drawings. The embodiment to be described below is merely an example, and embodiments to which the present disclosure is applied are not limited to the following embodiment. For example, in the following description, a multi-dimensional vector is used as data, but the present disclosure is not limited to a multi-dimensional vector and can be applied to any data such as time series data, structural data such as graphical data, and the like.

Note that in the text of the specification below, “Abar” refers to a symbol marked with a bar “-” on the head of “A”, and θ\hat{ } refers to a symbol marked with “\hat{ }” on the head of “θ”.

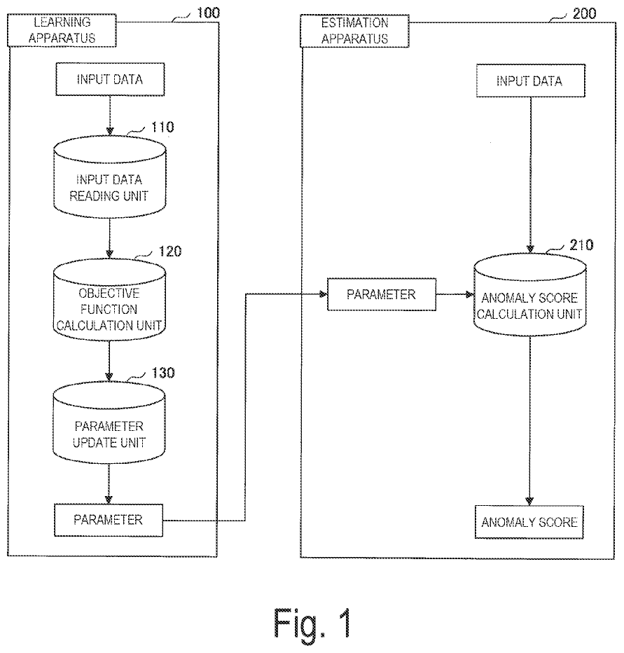

Configuration Example of System FIG. 1 illustrates a configuration example of a system according to an embodiment of the present disclosure. As illustrated in FIG. 1, the present system includes a learning apparatus 100 that calculates a value of a parameter related to an anomaly score from the input data, and an estimation apparatus 200 that calculates the anomaly score from the input data by using the value of the parameter calculated by the learning apparatus 100.

As illustrated in FIG. 1, the learning apparatus 100 includes an input data reading unit 110, an objective function calculation unit 120, and a parameter update unit 130. Further, the estimation apparatus 200 includes an anomaly score calculation unit 210. Details of each unit will be described below.

Note that the learning apparatus 100 and the estimation apparatus 200 may be one apparatus (for convenience, referred to as a learning & estimation apparatus). The learning & estimation apparatus includes an input data reading unit 110, an objective function calculation unit 120, a parameter update unit 130, and an anomaly score calculation unit 210.

The learning apparatus 100, the estimation apparatus 200, and the learning & estimation apparatus can be implemented by a computer. That is, the apparatus can be implemented by executing a program corresponding to processing executed by the apparatus by using hardware resources such as a CPU and a memory built in the computer. The above program can be recorded in a computer-readable recording medium (a portable memory or the like) and stored or distributed. In addition, the aforementioned program can also be provided through a network such as the Internet, an e-mail, or the like.

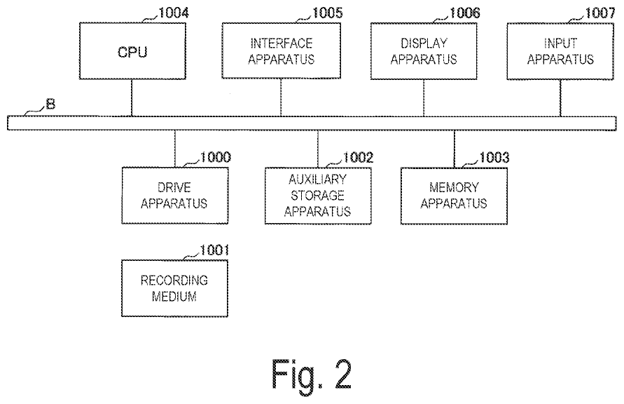

FIG. 2 is a diagram illustrating an example of the hardware configuration of the computer. The computer in FIG. 2 includes a drive apparatus 1000, an auxiliary storage apparatus 1002, a memory apparatus 1003, a CPU 1004, an interface apparatus 1005, a display apparatus 1006, an input apparatus 1007, and the like which are connected to each other through a bus B.

A program that implements processing in the computer is provided on, for example, a recording medium 1001 such as a CD-ROM or a memory card. When the recording medium 1001 storing the program is set in the drive apparatus 1000, the program is installed in the auxiliary storage apparatus 1002 from the recording medium 1001 through the drive apparatus 1000. However, the program does not necessarily have to be installed by the recording medium 1001, and may be downloaded from another computer through a network. The auxiliary storage apparatus 1002 stores the installed program and also stores necessary files, data, and the like.

The memory apparatus 1003 reads the program from the auxiliary storage apparatus 1002 and stores the program in a case where an instruction for starting the program is given. The CPU 1004 implements the functions related to the learning apparatus 100, the estimation apparatus 200, the learning & estimation apparatus, and the like according to the program stored in the memory apparatus 1003. The interface apparatus 1005 is used as an interface for connecting to a network and functions as an input unit and an output unit via the network. The display apparatus 1006 displays a graphical user interface (GUI) or the like according to the program. The display apparatus 1006 is also an example of the output unit. The input apparatus 1007 includes a keyboard, a mouse, buttons, a touch panel, and the like, and is used to input various operation instructions.

The processing contents of each unit will be described below. First, the learning apparatus 100 will be described.

Input Data Reading Unit 110 of Learning Apparatus 100

The input data reading unit 110 is given X={(xₙ, yₙ)}^{N}ₙ₋₁ as input data, and the input data is passed to the objective function calculation unit 120. Where xₙ=(xₙ₁, . . . , x_{nD}) is the D-dimensional feature vector of n-th data, and yₙ is the anomaly label. When data xₙ is abnormal, yₙ=1, and when not abnormal (when normal), yₙ=0. Here, N is an integer equal to or larger than 1.

Objective Function calculation unit 120 and Parameter Update Unit 130 of Learning Apparatus 100

In the present embodiment, as the anomaly score of the data, the anomaly score which decreases when the probability of occurrence of the data is high and increases when the probability of occurrence is low is used. For example, as the anomaly score, a negative logarithmic likelihood function can be used as illustrated in the following Equation (1).

[Equation 1]

anomaly-score(x)=−log p(x|θ), (1)

Here, θ is a parameter of the anomaly score. θ is also a parameter of the likelihood function p(x|θ).

Note that the anomaly score may be expressed by a function other than the likelihood function. For example, an anomaly score represented by a function used in unsupervised anomaly detection such as the reconfiguration error of the autoencoder may be used.

A function to represent the anomaly score may be referred to as a “predetermined function.” For example, the likelihood function p(x|θ) is an example of the predetermined function. “−log p (x|θ)” is also an example of the predetermined function. Alternatively, the “predetermined function” may be a function other than the likelihood function.

The parameter θ is a parameter related to the anomaly score and is not limited to a specific parameter, but is, for example, parameters of the probability of occurrence of abnormal data (or normal data), average and variance to represent a distribution of data, a neural network, or the like. The value of the likelihood function p(x|θ) represents the likelihood (likeness) where the data x is observed under the parameter θ.

As the likelihood function when calculating the anomaly score by using a likelihood function, any density function can be used, such as a normal distribution, a mixed normal distribution, a variational autoencoder, a neural autoregressive density function, and the like. For example, when the neural autoregressive density function is used as the likelihood function, the likelihood function p(x|θ) is represented by the following Equation (2).

$$[ Equation 2 ]$$

$$p ( x \vert θ ) = {\prod }_{d = 1}^{D} p ( {x}_{d} \vert {x}_{< d} ; θ ) , \qquad ( 2 )$$

In Equation (2) above, x_{<d}=[x₁, . . . , x_{d-1}] is each feature vector before d, and a mixed normal distribution represented by Equation (3) below, for example, can be used as a model for each feature.

$$[ Equation 3 ]$$

$$p ( {x}_{d} \vert {x}_{< d} ; θ ) = {\sum }_{k = 1}^{K} ( {π}_{dk} ( {x}_{< d} ; θ ) \times 𝒩 ( {x}_{d} \vert {μ}_{dk} ( {x}_{< d} ; θ ) , {σ}_{dk}^{2} ( {x}_{< d} ; θ ) ) ) , \qquad ( 3 )$$

Equation (3) above is a neural network in which K is the mixing number. N(⋅|μ, σ²) is a normal distribution of the average p and the variance σ², and π_{dk}(x_{<d};θ), μ_{dk}(x_{<d};θ), σ²_{dk}(x_{<d};θ) respectively define a mixing ratio, average, and variance for the d-th feature of the k-th component.

It should be noted that the distribution described above is an example. For example, other distributions can be used in such a manner that a Bernoulli distribution is used when the data is a binary variable, a Poisson distribution is used when the data is a non-negative integer, and a gamma distribution is used when the data is a non-negative real number.

The learning apparatus 100 estimates the parameter θ of the anomaly score such that the anomaly score of the normal data is low, and the anomaly score of the abnormal data is higher than the anomaly score of the normal data. To do so, for example, the θ is estimated to maximize the objective function shown in Equation (4) below, for example, to reduce the anomaly score of the normal data. The objective function calculation unit 120 calculates the objective function by using the input data and a value of θ, to estimate θ.

$$[ Equation 4 ]$$

$${L}^{′} ( θ ) = \frac{1}{\vert \overline{𝒜} \vert} {\sum }_{n ∈ \overline{𝒜}} log p ( {x}_{n} \vert θ ) , \qquad ( 4 )$$

Further, when solving the above-described objective function maximization problem, to make the anomaly score of the abnormal data higher than the anomaly score of the normal data, the constraint represented by the following Equation (5) can be used. More specifically, the constraint is a constraint when the parameter update unit 130 updates the parameter.

[Equation 5]

−log p(xₙ|θ)>−log p(x_{n′},|θ), for n∈ [symbol] , n′∈ [symbol] (5)

In Equation 4 and Equation 5, A denotes a collection of indices of the abnormal data, and Abar={n∈D|yₙ=0} indicates a collection of indices for normal data. That is, Equation (4) represents a value obtained by dividing the sum of logarithmic likelihoods of only normal data by the number of pieces of normal data. In addition, as described above. Equation (5) represents the constraint that the anomaly score of abnormal data (−log p(xₙ|θ), n∈A) is higher than the anomaly score of normal data (−log p(xₙ|θ), n′∈Abar). Based on this constraint, a parameter θ is calculated that maximizes Equation (4) while updating the parameter.

As input data, labeled data and unlabeled data may be provided. When labeled data and unlabeled data are provided, instead of the constraint of Equation (5), a constraint may be used in which the normal data is lower than the unlabeled data in the anomaly score to make the abnormal data higher than the unlabeled data in the anomaly score.

Maximizing the objective function by using constraints as described above is an example. As an efficient, unconstrained optimization, the parameter θ may be estimated by maximizing the objective function shown in Equation (6) below.

$$[ Equation 6 ]$$

$$L ( θ ) = {L}^{′} ( θ ) + \frac{λ}{\vert 𝒜 \vert \vert \overline{𝒜} \vert} {\sum }_{n ∈ 𝒜} {\sum }_{{n}^{′} ∈ \overline{𝒜}} f ( log \frac{p ( {x}_{{n}^{′}} \vert θ )}{p ( {x}_{n} \vert θ )} ) , \qquad ( 6 )$$

In Equation (6) above, λ≥0 is a hyperparameter, and f(⋅) is a sigmoidal function represented by Equation (7) below.

$$[ Equation 7 ]$$

$$f ( s ) = \frac{1}{1 + exp ( - s )} \qquad ( 7 )$$

The second term in Equation (6) is an example of a function in which a large value is taken when the anomaly score of the abnormal data is higher than the anomaly score of the normal data, and a small value is taken when the anomaly score of the abnormal data is lower than the anomaly score of the normal data. f(⋅) is a function in which a large value is taken when the anomaly score of the abnormal data is higher than the anomaly score of the normal data, and a small value is taken when the anomaly score of the abnormal data is lower than the anomaly score of the normal data, and a function other than Equation (6) may be used. The hyperparameter can be set, for example, by using developed data.

The method of maximizing the objective function described above is not limited to a specific method, but can be achieved using, for example, a stochastic gradient method. For example, the parameter update unit 130 estimates the parameter θ by a stochastic gradient method, by using the value of the objective function and the derivative value according to the parameter θ of the objective function.

Anomaly Score Calculation Unit 210 of Estimation Apparatus 200

The value of the parameter estimated by the learning apparatus 100 is θ\hat{ }. The estimation apparatus 200 receives the parameter θ\hat{ } and the data x* as the input data of the target for which the anomaly score is obtained. The anomaly score calculation unit 210 uses the parameter θ\hat{ } to calculate an anomaly score with respect to the data x* using Equation (8) below, and outputs the anomaly score.

[Equation 8]

anomaly-score(x*)=−log p(x*|\hat{θ}), (8)

### Processing Flow

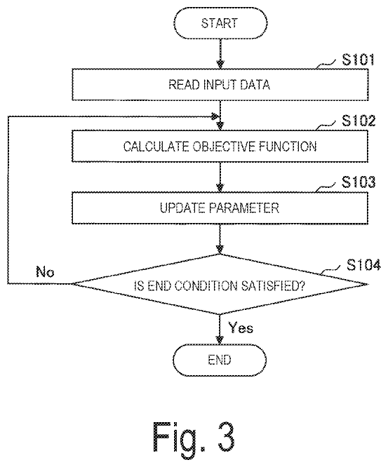

FIG. 3 is a flowchart showing processes of the learning apparatus 100.

In S101, the input data reading unit 110 reads the input data. The input data that has been read is passed to the objective function calculation unit 120. Note that the input data may be observation data that is received in real-time from a certain system, or the observed data which is stored in advance in a storage unit (HDD, memory, or the like) in the learning apparatus 100.

In S102, the objective function calculation unit 120 obtains the value of the objective function by calculating the objective function by using the input data and the value of the current parameter θ (at first, a preset initial value), and obtains the derivative value for the parameter θ of the objective function. The value of the objective function and the derivative value are passed to the parameter update unit 130.

In S103, the parameter update unit 130 updates the parameter θ such that the value of the objective function increases, by using the value of the objective function calculated in S102 and the derivative value.

The processes of S102, S103 are repeated until the end condition is satisfied. In other words, in S104, the parameter update unit 130 (or the objective function calculation unit 120) determines whether the end condition is satisfied. When the end condition is not satisfied, the process proceeds to S102, and when the end condition is satisfied, the process ends.

As the end condition, for example, the number of repetitions exceeding a certain value, the amount of change in the objective function value being smaller than a certain value, the amount of change in parameter being smaller than a certain value, or the like can be used.

When the value of the parameter θ is calculated (estimated) through the process of the learning apparatus 100, the anomaly score calculation unit 210 of the estimation apparatus 200 calculate the anomaly score of the target data, by using the estimated value of the parameter θ.

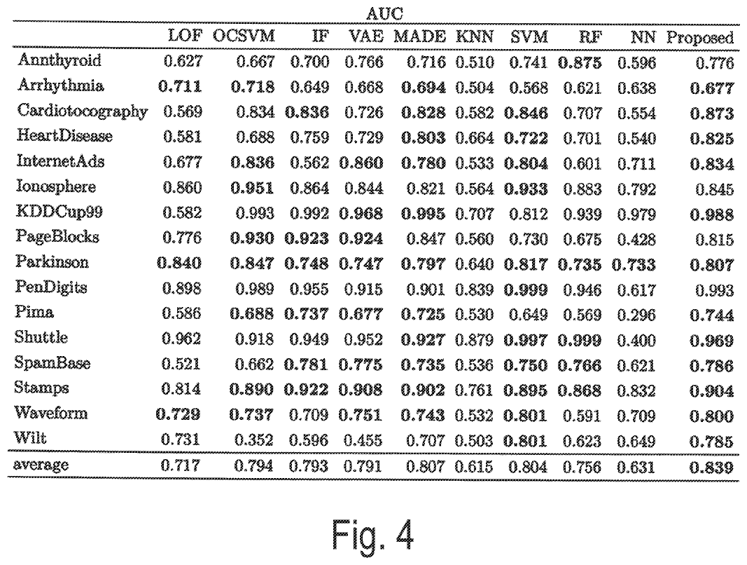

Evaluation Results Evaluation is performed by using 16 pieces of data to evaluate the technique according to the present disclosure described using the embodiments described above. The results are illustrated in FIG. 4. In the evaluation illustrated in FIG. 4, the Area Under the ROC Curve (AUC) is used as an evaluation index. The closer the AUC value is to 1, the higher the performance.

The 16 data names are illustrated on the left end of the table in FIG. 4. As a comparison target with respect to the method (Proposed) according to the present disclosure, as illustrated at the top of the table in FIG. 4, a local outlier factor (LOF), a one-class support vector machine (OCSVM), an isolation forest (IF), a valiational autoencoder (VAE), a deep masked autoencoder density estimator (MADE), a k-nearest neighbor (KNN), a support vector machine (SVM), a random forest (RF), and a neural network (NN) are used.

As illustrated in FIG. 4, it can be seen that the method (Proposed) according to the present disclosure achieves higher performance with more data than in other methods.

### CONCLUSION OF EMBODIMENT

As described above, at least the following matters are disclosed in the present specification.

### Item 1

A learning apparatus including: an input data reading unit configured to input data and a label indicating whether data is abnormal; an objective function calculation unit; and a parameter update unit. Here, the objective function calculation unit calculates a value of an objective function based on the label and a predetermined function for calculating an anomaly score of the data by applying a parameter relating to the anomaly score, by using the data and a value of the parameter. Further, the parameter update unit calculates a value of the parameter that maximizes the value of the objective function, by repeatedly executing the process by the objective function calculation unit, while updating the value of the parameter.

### Item 2

The learning apparatus according to item 1, wherein:
the anomaly score calculated using the predetermined function is an anomaly score of which a value decreases with respect to data having a high probability of occurrence, and the value increases with respect to data having a low probability of occurrence.

### Item 3

The learning apparatus according to item 1 or 2, wherein:
the parameter update unit is configured to update the value of the parameter by using a constraint to increase an anomaly score of abnormal data to be higher than an anomaly score of normal data.

### Item 4

The learning apparatus according to item 1 or 2, wherein the objective function includes a function that takes a large value when an anomaly score of abnormal data is higher than an anomaly score of normal data, and takes a small value when the anomaly score of the abnormal data is lower than the anomaly score of the normal data.

### Item 5

An estimation apparatus including an anomaly score calculation unit configured to calculates an anomaly score of data, by inputting the data into the predetermined function applied with the value of the parameter that maximizes the value of the objective function, obtained by the learning apparatus according to any one of items 1 to 4.

### Item 6

A parameter calculation method performed at a learning apparatus, the method including an input step, an objective function calculation step, and a parameter calculation step. Here, in the input step, data and a label indicating whether data is abnormal are input. Further, in the objective function calculation step, a value of an objective function based on the label and a predetermined function for calculating an anomaly score of the data by applying a parameter relating to the anomaly score is calculated by using the data and a value of the parameter. Further, in the parameter calculation step, a value of the parameter that maximizes the value of the objective function is calculated, by repeatedly executing the objective function calculation step, while updating the value of the parameter.

### Item 7

A program for causing a computer to function as each of the units in the learning apparatus according to any one of items 1 to 4.

### Item 8

A program for causing a computer to function as the anomaly score calculation unit in the estimation apparatus according to item 5.

Although the present embodiment has been described above, the present disclosure is not limited to such a specific embodiment, and various modifications and changes can be made without departing from the gist of the present disclosure described in the claims.

### REFERENCE SIGNS LIST

100 Learning apparatus
110 Input data reading unit
120 Objective function calculation unit
130 Parameter update unit
200 Estimation apparatus
210 Anomaly score calculation unit
1000 Drive apparatus
1001 Recording medium
1002 Auxiliary storage apparatus
1003 Memory apparatus
1004 CPU
1005 Interface apparatus
1006 Display apparatus
1007 Input apparatus

1. A learning apparatus comprising:
an input data reader configured to input data and a label indicating whether the data is abnormal;
an objective function generator configured to generate a value of an objective function based on the label and a predetermined function for determining an anomaly score of the data by applying a parameter relating to the anomaly score, by using the data and a value of the parameter; and
a parameter updater configured to update a value of the parameter that maximizes the value of the objective function by repeatedly executing a process by the objective function calculation unit while updating the value of the parameter.

2. The learning apparatus according to claim 1, wherein:
the anomaly score determined using the predetermined function is an anomaly score of which a value decreases with respect to data having a high probability of occurrence, and the value increases with respect to data having a low probability of occurrence.

3. The learning apparatus according to claim 1, wherein:
the parameter updater is configured to update the value of the parameter by using a constraint to increase an anomaly score of abnormal data to be higher than an anomaly score of normal data.

4. The learning apparatus according to claim 1, wherein:
the objective function includes a function that takes a large value when an anomaly score of abnormal data is higher than an anomaly score of normal data, and takes a small value when the anomaly score of the abnormal data is lower than the anomaly score of the normal data.

5. The learning apparatus according to claim 1, the apparatus further comprising:
an anomaly score determiner configured to determine the anomaly score of data, by inputting the data into the predetermined function applied with the value of the parameter that maximizes the value of the objective function, obtained by the learning apparatus.

6. A parameter calculation method at a learning apparatus, the method comprising:
inputting, by an input data reader, data and a label indicating whether the data is abnormal;
generating, by an objective function generator, a value of an objective function based on the label and a predetermined function for calculating an anomaly score of the data by applying a parameter relating to the anomaly score, by using the data and a value of the parameter; and
updating, by a parameter updater, a value of the parameter that maximizes the value of the objective function by repeatedly executing the generating of the value of the objective function while updating a value of the parameter.

7. A computer-readable non-transitory recording medium storing computer-executable program instructions that when executed by a processor cause a computer system to:
receive, by an input data reader, data and a label indicating whether the data is abnormal;
generate, by an objective function generator, a value of an objective function based on the label and a predetermined function for determining an anomaly score of the data by applying a parameter relating to the anomaly score, by using the data and a value of the parameter; and
a parameter updater configured to update a value of the parameter that maximizes the value of the objective function by repeatedly executing a process by the objective function calculation unit while updating the value of the parameter.

8. The computer-readable non-transitory recording medium according to claim 7, the computer-executable program instructions when executed further causing the computer system to:
an anomaly score determiner configured to determine the anomaly score of data, by inputting the data into the predetermined function applied with the value of the parameter that maximizes the value of the objective function, obtained by the learning apparatus.

9. The learning apparatus according to claim 2, wherein:
the parameter updater is configured to update the value of the parameter by using a constraint to increase an anomaly score of abnormal data to be higher than an anomaly score of normal data.

10. The parameter calculation method according to claim 6, wherein:
the anomaly score determined using the predetermined function is an anomaly score of which a value decreases with respect to data having a high probability of occurrence, and the value increases with respect to data having a low probability of occurrence.

11. The parameter calculation method according to claim 6, wherein:
the parameter updater is configured to update the value of the parameter by using a constraint to increase an anomaly score of abnormal data to be higher than an anomaly score of normal data.

12. The parameter calculation method according to claim 6, wherein:
the objective function includes a function that takes a large value when an anomaly score of abnormal data is higher than an anomaly score of normal data, and takes a small value when the anomaly score of the abnormal data is lower than the anomaly score of the normal data.

13. The parameter calculation method according to claim 6, the method further comprising:
determining, by an anomaly score determiner, the anomaly score of data, by inputting the data into the predetermined function applied with the value of the parameter that maximizes the value of the objective function, obtained by the learning apparatus.

14. The parameter calculation method according to claim 10, wherein:
the parameter updater is configured to update the value of the parameter by using a constraint to increase an anomaly score of abnormal data to be higher than an anomaly score of normal data.

15. The computer-readable non-transitory recording medium according to claim 7, wherein:
the anomaly score determined using the predetermined function is an anomaly score of which a value decreases with respect to data having a high probability of occurrence, and the value increases with respect to data having a low probability of occurrence.

16. The computer-readable non-transitory recording medium according to claim 7, wherein:
the parameter updater is configured to update the value of the parameter by using a constraint to increase an anomaly score of abnormal data to be higher than an anomaly score of normal data.

17. The computer-readable non-transitory recording medium according to claim 7, wherein:
the objective function includes a function that takes a large value when an anomaly score of abnormal data is higher than an anomaly score of normal data, and takes a small value when the anomaly score of the abnormal data is lower than the anomaly score of the normal data.

18. The computer-readable non-transitory recording medium according to claim 15, wherein:
the parameter updater is configured to update the value of the parameter by using a constraint to increase an anomaly score of abnormal data to be higher than an anomaly score of normal data.

19. The computer-readable non-transitory recording medium according to claim 15, wherein:
the objective function includes a function that takes a large value when an anomaly score of abnormal data is higher than an anomaly score of normal data, and takes a small value when the anomaly score of the abnormal data is lower than the anomaly score of the normal data.

20. The computer-readable non-transitory recording medium according to claim 15, the computer-executable program instructions when executed further causing the computer system to: an anomaly score determiner configured to determine the anomaly score of data, by inputting the data into the predetermined function applied with the value of the parameter that maximizes the value of the objective function, obtained by the learning apparatus.
